(19) United States
(12) Patent Application Publication
(10) Pub. No.: US 2009/0300315 A1
(43) Pub. Date: Dec. 3, 2009

(54) Reserve Pool Management in Virtualized Storage Systems

(75) Inventors: John P. Agombar, Hampshire (GB); Christopher B. Beeken, Hants (GB); Stephanie Machleidt, Winchester (GB); Simon Walsh, Hampshire (GB)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/307,869

(22) PCT Filed: Jun. 20, 2007
(86) PCT No.: PCT/EP2007/056107

§ 371 Date: Jan. 7, 2009

(30) Foreign Application Priority Data
Jul. 8, 2006 (GB) 0613660.0

(51) Int. Cl. G06F 12/02; G06F 12/00

(52) U.S. Cl. 711/170; 711/E12.001; 711/E12.002

(57) ABSTRACT

An apparatus for managing pooled real storage having a usable real storage pool and a reserve real storage pool in a virtualized storage system, comprises an extent controller for allocating and freeing storage extents in said usable real storage pool; a storage use monitor for monitoring storage use in said usable real storage pool; and a reserve pool manager responsive to said storage use monitor for transferring storage extents between said usable real storage pool and said reserve real storage pool.

### BACKGROUND

The present invention relates to technology for controlling virtualized storage systems, and in particular to a technology for managing pools of storage in virtualized storage systems.

The rapidly growing requirements placed on virtualised storage systems have increased the complexity of predicting where additional storage capacity will be required. A virtualised storage system typically divides the real storage into a number of pools each of which may contain storage devices with similar characteristics. Virtual storage devices are then created from the unallocated storage available within a single pool. When a pool runs out of unallocated storage, new storage must be added to that pool by the systems administrator before further virtual devices can be created or existing ones expanded. This means that creating new virtual devices (or expanding existing ones) becomes a two stage process—adding a device to the real storage pool and then creating or expanding a virtual device. The complexity of this activity is increased by the existence of two “views” of the storage—the virtual view as presented to applications and the real view, as presented to the underlying physical storage control components. Furthermore, the use of the underlying real storage may be manipulated automatically by the physical storage infrastructure without affecting the virtual view, for example, by automated consolidation of the real extents that compose a virtual file in order to improve retrieval efficiency. Correlating the information from the two views of storage thus presents considerable difficulty to the system administrator.

The problem becomes more complex with late allocated virtual devices as the amount of allocated storage within a pool can change at any time (outside the control of a systems administrator). Typically when a late allocated device needs to allocate more storage and none is available the device is taken offline. The systems administrator must monitor the unallocated space within all pools and ensure that new storage is added to those pools where unallocated space is running low before virtual devices within that pool become unavailable. In such an environment the decision as to which pool to add the new storage to is complex.

### SUMMARY

In one illustrative embodiment, an apparatus is provided for managing pooled real storage having a usable real storage pool and a reserve real storage pool in a virtualized storage system. An extent controller is configured to allocate and free storage extents in the usable real storage pool. A storage use monitor is configured to monitor storage use in the usable real storage pool. A reserve pool manager responsive to the storage use monitor is configured to transfer storage extents between the usable real storage pool and the reserve real storage pool.

In another illustrative embodiment, a method is provided for managing pooled real storage having a usable real storage pool and a reserve real storage pool in a virtualized storage system. The method comprises allocating and freeing storage extents by an extent controller in the usable real storage pool. The method further comprises monitoring storage use in the usable real storage pool and responsive to monitoring storage use, transferring by a reserve pool manager storage extents between the usable real storage pool and the reserve real storage pool.

In another illustrative embodiment, a computer program comprises a computer recordable medium having a computer readable program recorded thereon. The computer readable program, when loaded into a computer system and executed thereon, causes said computer system to allocate and free storage extents by an extent controller in said usable real storage pool, monitor storage use in said usable real storage pool, and responsive to monitoring storage use, transfer by a reserve pool manager storage extents between said usable real storage pool and said reserve real storage pool.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

FIG. 1 shows in schematic form an arrangement of components forming a virtualized storage system in which aspects of the illustrative embodiments may be implemented;

FIG. 2 shows an arrangement of apparatus for reserve pool management in a virtualized storage system in accordance with an illustrative embodiment; and

FIG. 3 shows in flowchart form operation of reserve pool management in a virtualized storage system in accordance with an illustrative embodiment.

### DETAILED DESCRIPTION

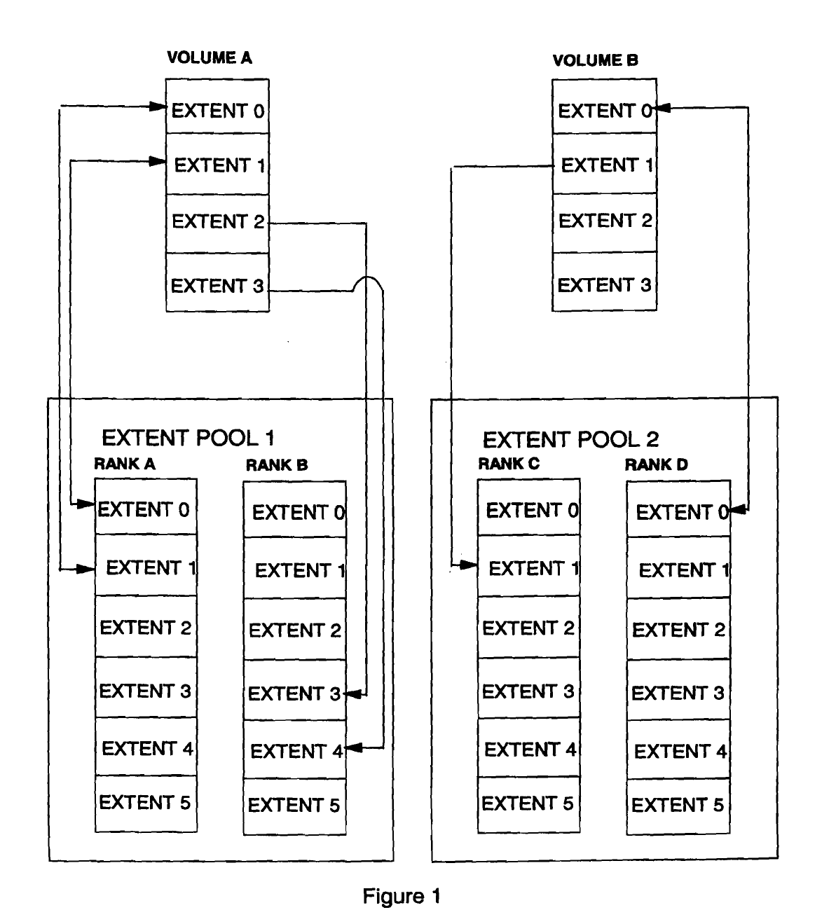

Turning to FIG. 1, there is shown an arrangement of components forming a typical virtualized storage system in which aspects of the illustrative embodiments may be implemented. The basic unit from which the user's view of the data is constructed is called an extent. The physical storage device is called a rank and is made up of extents. Ranks are grouped together to form an extent pool and a volume is constructed as a sequence of extents that are mapped to a subset of extents from an extent pool. For example in FIG. 1 Volume A is constructed from extents (rankA,extent 0), (rankA,extent 1),(rankB,extent3),(rankB,extent4) from extent pool 1.

A late allocated volume is one which is not mapped to any extents in a pool until that extent is written to. An extent from the pool is then mapped to the volume and the data is written to it. For example in FIG. 1 volume B has 4 extents but only 2 have been mapped to rank extents, namely (rankC,extent1) and (rankD,extent0).

A data migration is a scheme that can modify the rank extents that hold the data for a volume. It is therefore a sequence of operations that moves data that is mapped to a volume currently held on an extent (the source extent) to another extent (the target extent). The target extent replaces the source extent for the volume's data map. For example a data migration may modify the mapping for volume A so that it is constructed from extents (rankB,extent 0), (rankB,extent1), (rankB,extent3), and (rankB,extent4) from extent pool 1.

A preferred embodiment creates a new kind of pool that contains ranks that are unavailable to be used by volumes. We call this type of pool a reserve pool. The systems administrator adds ranks to a reserve pool when new storage capacity is added to the system. The system can then move any rank from a reserve pool to any normal extent pool as additional capacity.

A rank may be moved from a reserve pool to a normal pool in the following situations:

1. A pool has a predetermined minimum number of extents that must be available for over-allocation. If the number of extents not mapped to a volume falls below this threshold a rank will be taken from a reserve pool. If no ranks are available in a reserve pool the late allocated volume may be offlined.
2. A volume is created or expanded and there are not enough free extents in the pool, but enough additional extents can be found by adding in ranks from a reserve pool. The appropriate ranks are then taken from a reserve pool.
3. A volume is migrated from one pool to another and there are not enough free extents in the target pool, but enough additional extents can be found by adding in ranks from a reserve pool. The appropriate ranks are then taken from a reserve pool.

A rank may be moved from a normal pool to a reserve pool in the following situations:

1. A volume is deleted or shrunk and the result may mean that the extent pool has enough free capacity that a rank could be returned to a reserve pool. This may require migrating all extents on the rank to be removed onto other ranks in the pool and once complete the rank can be returned to a reserve pool.
2. A volume is migrated to another extent pool. This could result in the same procedure as in 1.
3. When extents are deallocated for a late allocation volume, for example due to writing zeros to an extent. This could result in the same procedure as in 1.

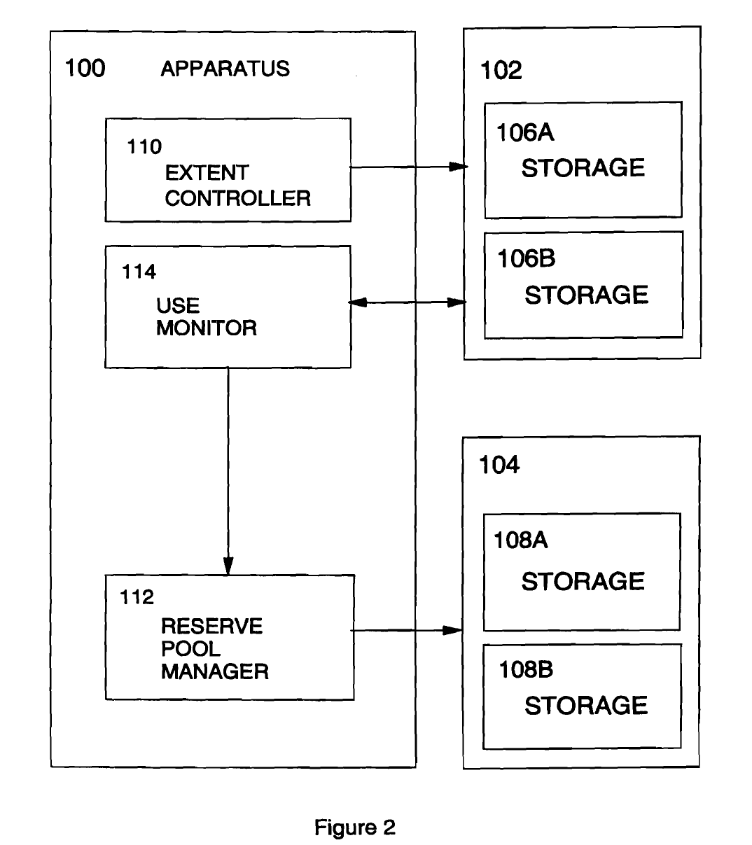

Turning now to FIG. 2, there is shown an arrangement of apparatus for reserve pool management in a virtualized storage system in accordance with an illustrative embodiment.

In FIG. 2, an apparatus 100, for example, a storage control component, is operable to control normal pool 102 and reserve pool 104. Normal pool 102 comprises storage 106A and 106B. Reserve pool 104 initially comprises storage 108A. Apparatus 100 comprises storage extent controller 10 for allocating storage extents in storage 106A and 106B of normal pool 102. Apparatus 100 further comprises reserve pool manager 112 for managing reserve pool 104. When storage 108B is made available to the system, reserve pool manager 112 accepts it into reserve pool 104. Apparatus 100 may further comprise storage use monitor 114, which is operative in communication with normal pool 102 to monitor usage of storage 106A and 106B. If usage monitor 114 detects that storage use in normal pool 102 has risen above a predetermined threshold, it alerts reserve pool manager 112, which is operable to assign storage from reserve pool 104 to normal pool 102. It may, for example, transfer storage 108A from reserve pool 104 to normal pool 102, leaving storage 108B in the reserve pool 104 as a reserve for later use. If usage monitor 114 detects that storage use in normal pool 102 has fallen below a predetermined threshold, it alerts reserve pool manager 112, which is operable to return storage from normal pool 102 to reserve pool 104. It may, for example, transfer storage 106A from normal pool 102 to reserve pool 104, leaving storage 106B in the normal pool and keeping storage 106A as a reserve for later use.

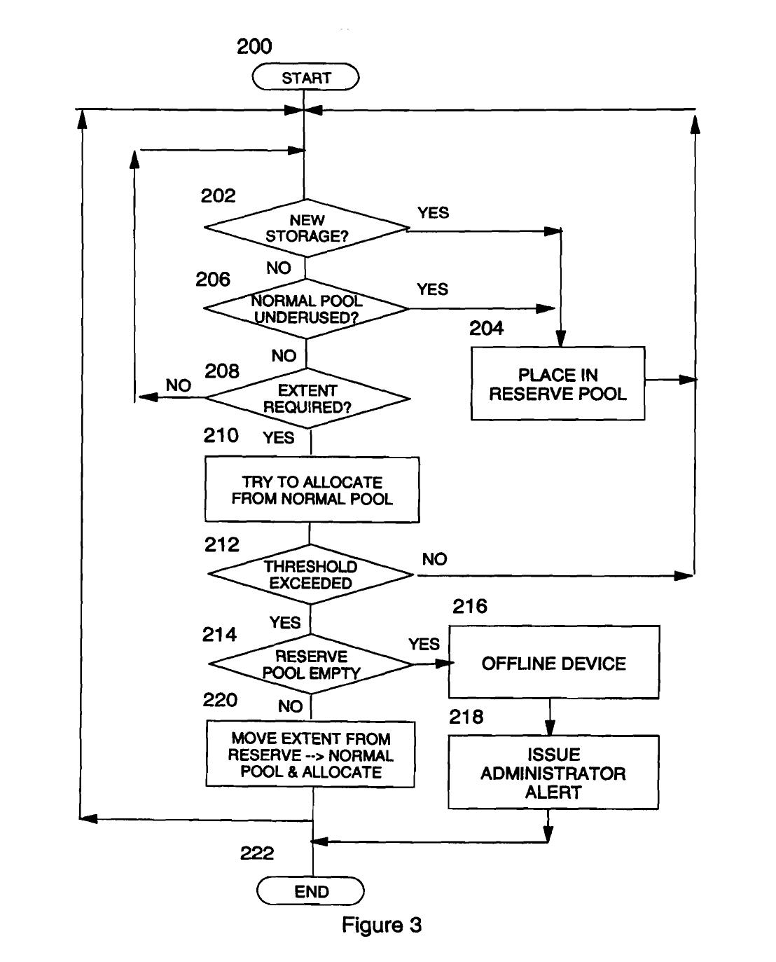

Turning now to FIG. 3, there are shown in flowchart form operation of reserve pool management in a virtualized storage system in accordance with an illustrative embodiment. In FIG. 3, the steps begin at START step 200. At test step 202, a determination is made whether new storage has been connected to the system, and if so, the storage is placed in the reserve pool at process step 204, and the method steps continue as from START step 200.

If no new storage has been detected at step 202, a test is made at test step 206 to determine whether there is underuse of normal pool storage, that is, if any storage in a normal pool is unused and can be freed. If so, the storage is placed in the reserve pool at process step 204, and the method steps continue as from START step 200.

If, at test step 208, it is determined that one or more extents are required for allocation in the normal pool, an attempt is made at process step 210 to allocate storage from the normal pool. If, at test step 212, it is determined the allocation attempt has been successful, the method steps continue as from START step 200. However, if test step 212 shows that the threshold would be exceeded by allocation of storage from the normal pool, a further test is made at test step 214 to determine if the reserve pool has available storage, or if the reserve pool is empty.

If the reserve pool is determined at test step 214 to be empty, the normal system response as in the prior art is processed. In the exemplary embodiment, this takes the form of placing the device in need of additional storage in an offline state at process step 216 and issuing an administrator alert at process step 218. If the reserve pool is determined at test step 214 not to be empty, at process step 220 the extent is moved from the reserve pool to the normal pool and allocated to satisfy the attempt from process step 210, and the method steps continue as from START step 200. The process completes at END step 222.

The illustrative embodiments thus advantageously address the problem of providing a technical framework for controlling virtualized storage systems, and in particular to a technology for managing pools of storage in virtualized storage systems.

It will be clear to one of ordinary skill in the art that all or part of the illustrative embodiments may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the illustrative embodiments may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

The illustrative embodiments may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, using a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In an alternative, the illustrative embodiments may be realized in the form of a computer implemented method of deploying a service comprising steps of deploying computer program code operable to, when deployed into a computer infrastructure and executed thereon, cause said computer system to perform all the steps of the method.

In a further alternative, the illustrative embodiments may be realized in the form of a data carrier having functional data thereon, said functional data comprising functional computer data structures to, when loaded into a computer system and operated upon thereby, enable said computer system to perform all the steps of the method.

It will be clear to one skilled in the art that many improvements and modifications can be made to the foregoing example embodiments without departing from the scope of the present invention.

1. An apparatus for managing pooled real storage in a virtualized storage system, the apparatus comprising:
an extent controller configured to allocate and free storage extents in a usable real storage pool within the pooled real storage;
a storage use monitor configured to monitor storage use in said usable real storage pool; and
a reserve pool manager responsive to said storage use monitor configured to transfer storage extents between said usable real storage pool and a reserve real storage pool within the pooled real storage.

2. An apparatus as claimed in claim 1, wherein said storage use monitor is adapted to monitor storage use against a use level selected from:
an upper threshold use level; or
a lower threshold use level.

3. An apparatus as claimed in claim 2, wherein said storage use monitor, responsive to a storage request exceeding said upper threshold use level, is operable to transfer storage extents from said reserve real storage pool to said usable real storage pool.

4. An apparatus as claimed in claim 2, wherein said storage use monitor, responsive to storage use passing below said lower threshold use level, is operable to transfer storage extents from said usable real storage pool to said reserve real storage pool.

5. An apparatus as claimed in claim 1, wherein said reserve pool manager is adapted to receive newly-attached real storage into said reserve real storage pool.

6. A method for managing pooled real storage in a virtualized storage system, the method comprising:
allocating and freeing storage extents by an extent controller in said usable real storage pool;
monitoring storage use in said usable real storage pool; and
responsive to monitoring storage use, transferring by a reserve pool manager, storage extents between said usable real storage pool and said reserve real storage pool.

7. A method as claimed in claim 6, wherein monitoring storage use applies a test against a use level selected from:
an upper threshold use level; or
a lower threshold use level.

8. A method as claimed in claim 7, wherein monitoring storage use, responsive to a storage request exceeding said upper threshold use level, causes transfer of storage extents from said reserve real storage pool to said usable real storage pool.

9. A method as claimed in claim 7, wherein monitoring storage use, responsive to storage use passing below said lower threshold use level, causes transfer of storage extents from said usable real storage pool to said reserve real storage pool.

10. A computer program comprising a computer recordable medium having a computer readable program recorded thereon, wherein the computer readable program, when loaded into a computer system and executed thereon, causes said computer system to:
allocate and free storage extents by an extent controller in said usable real storage pool;
monitor storage use in said usable real storage pool; and
responsive to monitoring storage use, transfer by a reserve pool manager storage extents between said usable real storage pool and said reserve real storage pool.

11. The method as claimed in claim 6, further comprising:
adding newly-attached storage into the reserve real storage pool.

12. The method as claimed in claim 6, further comprising:
responsive to a storage request causing a number of extents in the usable real storage pool not mapped to a volume falling below a threshold, transferring storage extents from said reserve real storage pool to said usable real storage pool.

13. The method as claimed in claim 8, wherein the storage request comprises creation of a new volume or expansion of an existing volume.

14. The method as claimed in claim 8, wherein the storage request comprises migration of a volume from a source pool to the usable real storage pool.

15. The method as claimed in claim 9, wherein the storage request comprises deletion or shrinking of an existing volume.

16. The method as claimed in claim 9, wherein the storage request comprises migration of a volume from the usable real storage pool to a target real storage pool.

17. A computer program product as claimed in claim 10, wherein monitoring storage use applies a test against a use level selected from:
an upper threshold use level; or
a lower threshold use level.

18. A computer program product as claimed in claim 17, wherein monitoring storage use, responsive to a storage request exceeding said upper threshold use level, causes transfer of storage extents from said reserve real storage pool to said usable real storage pool.

19. A computer program product as claimed in claim 17, wherein monitoring storage use, responsive to storage use passing below said lower threshold use level, causes transfer of storage extents from said usable real storage pool to said reserve real storage pool.

20. The method as claimed in claim 6, wherein the computer readable program further causes the computer system to:
responsive to a storage request causing a number of extents in the usable real storage pool not mapped to a volume falling below a threshold, transfer storage extents from said reserve real storage pool to said usable real storage pool.
